(19) United States
(12) Patent Application Publication
(10) Pub. No.: US 2010/0243551 A1
(43) Pub. Date: Sep. 30, 2010

(54) MODULAR ASSEMBLIES OF FILTER SYSTEMS

(75) Inventor: John C. Ruprecht, North Oaks, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: CLEAN & CLEAR CORPORATION, White Bear Lake, MN (US)

(21) Appl. No.: 12/730,544

(22) Filed: Mar. 24, 2010

Related U.S. Application Data
(60) Provisional application No. 61/163,115, filed on Mar. 25, 2009.

(51) Int. Cl. B01D 35/153

(52) U.S. Cl. 210/235

(57) ABSTRACT

Modular assemblies of filtering systems provide options for installing any number of filter elements in parallel arrangement. The assemblies may be formed by coupling together and placing at least two modular manifold parts on a mounting bracket, and engaging a mounting ring, which is slideably engaged about a sidewall that surrounds each filter element, with a quick connect member of the mounting bracket. The at least two modular manifold parts may be selected from a modular manifold kit that includes either a plurality of a first type of part or at least one first type of part and at least one second type of part. The first type of part includes first and second channel portions to support inflow and outflow for each filter element and the second type of part is configured to serve as both an end cap and an adapter for the first type of part.

### RELATED APPLICATION

This application claims priority to U.S. provisional application Ser. No. 61/163,115, which was filed on Mar. 25, 2009 and is hereby incorporated by reference, in its entirety.

### TECHNICAL FIELD

The present invention pertains to filter systems and more particularly to modular assemblies thereof.

### BACKGROUND

Filtering a fluid for household consumption and/or industrial processes is often desirable. A filter system, which is installed between a main source, and one or more supply lines that extend throughout a facility or processing line, typically requires routine maintenance, in particular, to replace spent filters. The schedule for filter replacement is dependent upon both the amount of fluid that passes through the filter system and the type of filter system.

### SUMMARY

A modular assembly of a filter system, according to embodiments of the present invention, facilitates relatively easy assembly and disassembly thereof, and provides options for installing any number of filter elements in a parallel arrangement. The system may include a mounting bracket, for example, to attach the system to a wall, which mounting bracket has the capacity to support both a plurality of filter modules and a modular manifold assembly, for example, wherein the manifold assembly is supported on a top side of the bracket and the filter modules from a bottom, or lower side of the bracket. Preferably, the assembly further includes a quick-connect-and-release type coupling for securing each filter module to the mounting bracket. Each coupling may include two parts that come together at a camming and interlocking interface.

Each filter module preferably includes a filter element contained within a sidewall. The filter element preferably includes a porous ceramic sidewall surrounding a core, which core is preferably formed of granular activated carbon. The core of the filter element is in fluid communication with an inlet port of the filter module, which, when connected to the manifold assembly, receives an inflow of fluid from a channel portion of the modular manifold assembly, via a corresponding side opening of one of the manifold parts of the modular assembly. The filter module further includes an outlet port located alongside the inlet port so that the fluid, which has passed through filter element, may flow from the filter module and into another channel portion of the manifold assembly, via another corresponding side opening of the same manifold part. According to some preferred embodiments, push-in type fittings surround the inflow and outflow channels, and work in conjunction with the aforementioned quick-connect-and-release type couplings, so as to allow for relatively simple assembly of each filter module with the modular manifold assembly, for example, via access, from the lower side of the mounting bracket, to the aforementioned side openings of the manifold part. Furthermore, the inlet and outlet ports of the filter module, as well as the openings through the mounting bracket that provide the aforementioned access, may be asymmetrically positioned to provide a keying feature for the proper connection of the aforementioned channel portions of the manifold assembly.

The modular manifold assembly includes at least first and second parts, which may be selected from a group or kit of modular manifold parts according to the desired number of filter modules for the system. The first and second parts may be of the same or different types. The modular design of the manifold assembly and the filter modules provides flexibility to add and remove filter modules to/from the system.

A first type of part in the group of modular manifold parts includes a first channel portion and a second channel portion; one of the channel portions may be part of an inflow channel of the manifold assembly, and the other may be a part of an outflow channel of the manifold assembly, depending upon the number of filter modules, which number dictates an arrangement of the parts in the assembly. The first and second channel portions extend alongside one another between first and second ends of the first type of part. The first type of part preferably includes two pairs of side openings, a first pair extending into, or communicating with the first channel portion and a second pair extending into, or communicating with the second channel portion; each side opening is adapted to reversibly connect to either the inlet port or the outlet port of a filter module. When each side opening that extends into the first channel portion connects with a corresponding inlet port of each filter module, each side opening that extends into the second channel portion connects with a corresponding outlet port of each filter module.

The first channel portion of the first type of part also has a first, main opening, at a first end of the part and a second opening at a second end of the part, while the second channel portion has only an opening at the second end of the part and a terminal end wall within the part. Each of the openings of the first channel portion is preferably surrounded by a fitting, wherein the fitting for the first, main opening may be formed by a male thread, and the fitting for the second opening may be formed by a male push-in type fitting. The opening of the second channel portion, which is positioned alongside the second opening of the first channel portion, is surrounded by a fitting which is adapted to mate with the fitting that surrounds the second main opening of the first channel portion, for example, a female push-in type fitting, such as a John Guest coupler. Thus, two of the first type of parts may be fitted together at the second ends thereof, in order to accommodate more filters in the system.

A second type of part in the group of modular manifold parts is useful for terminating the first channel portion of the first type of modular manifold part, when the desired number of filter modules for the system does not exceed the number of pairs of side openings of the first type of part. The second type of part includes a dead-end bore and a channel. An opening of the dead end bore is adapted to mate with the second opening into the first channel portion of the first type of part, and to, thereby, terminate the first channel portion. An opening into the channel of the second type of part is adapted to mate with the opening into the second channel portion of the first type of part in order to extend the second channel portion to an opening of the channel at the opposite end of the second type of part. This opening at the opposite end may be surrounded by a male threaded fitting.

### BRIEF DESCRIPTION OF THE DRAWINGS

The following drawings are illustrative of particular methods and embodiments of the present disclosure and, therefore, do not limit the scope of the invention. The drawings are not to scale (unless so stated) and are intended for use in conjunction with the explanations in the following detailed description. Methods and embodiments will hereinafter be described in conjunction with the appended drawings, wherein like numerals denote like elements.

FIG. 1 is a perspective view of a modular assembly of a filter system, according to some embodiments of the present invention.

FIG. 2A is a side view of a portion of the modular assembly, according to some embodiments.

FIG. 2B is a plan view of the portion of the modular assembly that is shown in FIG. 2A.

FIG. 2C is a cross-section view, through section line A-A of FIG. 1, according to some embodiments.

FIG. 3 is a cross-section view taken along an extent of inflow and outflow channels of a modular manifold assembly of the filter system of FIG. 1, according to some embodiments.

FIG. 4 is a perspective view of a group of modular manifold parts, according to some embodiments of the present invention.

FIG. 5A is a perspective view an alternative modular assembly of a filter system, according to some embodiments.

FIG. 5B is a cross-section view, taken along an extent of inflow and outflow channels of the modular manifold assembly of the alternative modular assembly shown in FIG. 5A, according to some embodiments.

FIG. 6 is a cross-section view, taken along an extent of inflow and outflow channels, of a modular manifold assembly for yet another alternative modular assembly of a filter system, according to some embodiments.

### DETAILED DESCRIPTION

The following detailed description is exemplary in nature and is not intended to limit the scope, applicability, or configuration of the invention in any way. Rather, the following description provides practical illustrations for implementing exemplary methods and embodiments. Those skilled in the art will recognize that many of the examples provided have suitable alternatives that can be utilized.

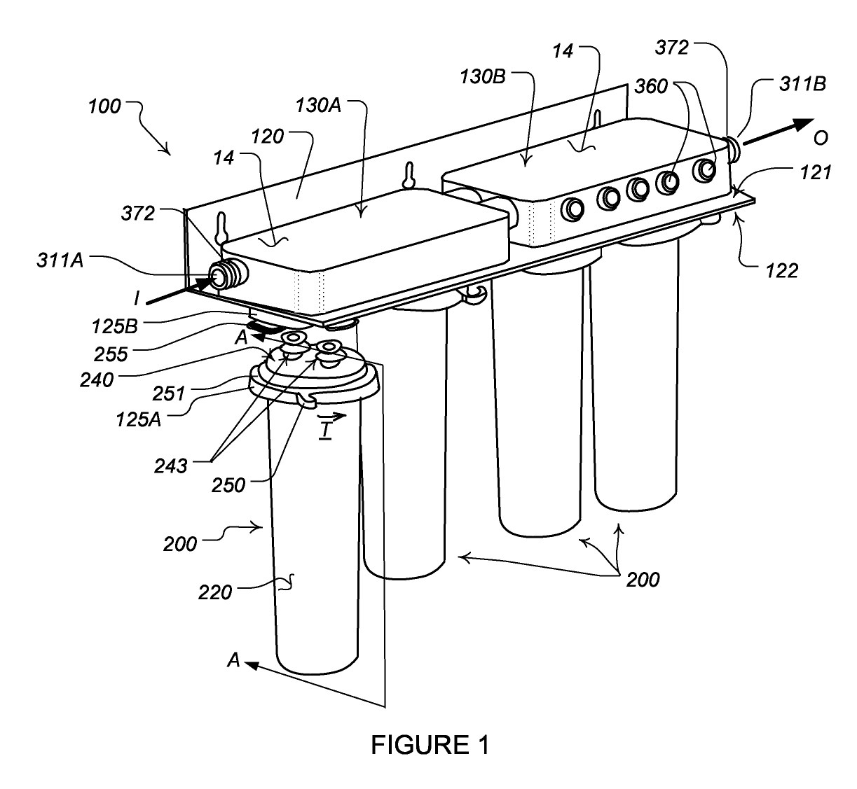

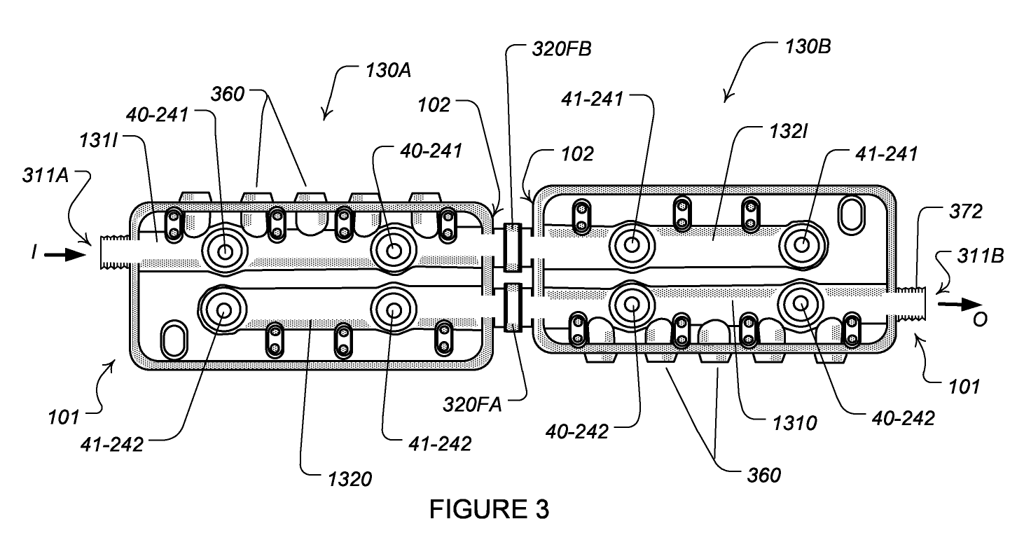

FIG. 1 is a perspective view of a modular assembly of a filter system 100, according to some embodiments of the present invention. FIG. 1 illustrates filter system 100 including four filter modules 200 connected together, for parallel flow therethrough, by a modular manifold assembly. The modular manifold assembly is shown including manifold parts 130A and 130B, which are joined together such that flow, per arrow I, enters a main opening 311A of manifold part 130A and exits a main opening 311B of manifold part 130B, per arrow O. The flow through manifold parts 130A, 130B will be described below, in conjunction with FIG. 3. FIG. 1 further illustrates manifold parts 130A, 130B supported on a first side 121 of a mounting bracket 120, and three of the four filter modules 200 joined to manifold parts 130A, 130B and to mounting bracket 120, so as to extend from a second side 122 of bracket 120. According to an exemplary embodiment, a length of the illustrated modular manifold assembly of system 100, from opening 311A to opening 311B, is between approximately 23 inches and approximately 24 inches. An overall height of system 100 depends upon the size of filter module employed: if each filter module 200 has a height of approximately 10 inches, the overall height of system 100, from the lowermost end of each filter module 200 to an upper side 14 of each of parts 130A, 130B is approximately 14 inches; if each filter module 200 has a height of approximately 16 inches, the overall height is approximately 20 to 20.5 inches; if each filter module 200 has a height of approximately 24 inches, the overall height is approximately 28 to 28.5 inches; and if each filter module 200 has a height of approximately 30 inches, the overall height is approximately 34 to 34.5 inches.

According to the illustrated embodiment, when each filter module 200 is joined to the corresponding manifold part 130A, 130B, each module 200 is also secured to mounting bracket 120 by a quick-connect-and-release type coupling, which includes a mounting ring 125A and a quick connect member 125B, wherein each quick connect member 125B is mounted on second side 122 of bracket 120, and each mounting ring 125A is mounted around a corresponding filter module 200. According to preferred embodiments, mounting ring 125A is slideably engaged about a sidewall 220 of each module 200 and may be rotated with respect to sidewall 220, for example, per arrow T, in order to interlock each mounting ring 125A with the corresponding quick connect member 125B. FIG. 1 further illustrates mounting ring 125A including a lever 250, to which a force may be applied in order to rotate mounting ring 125.

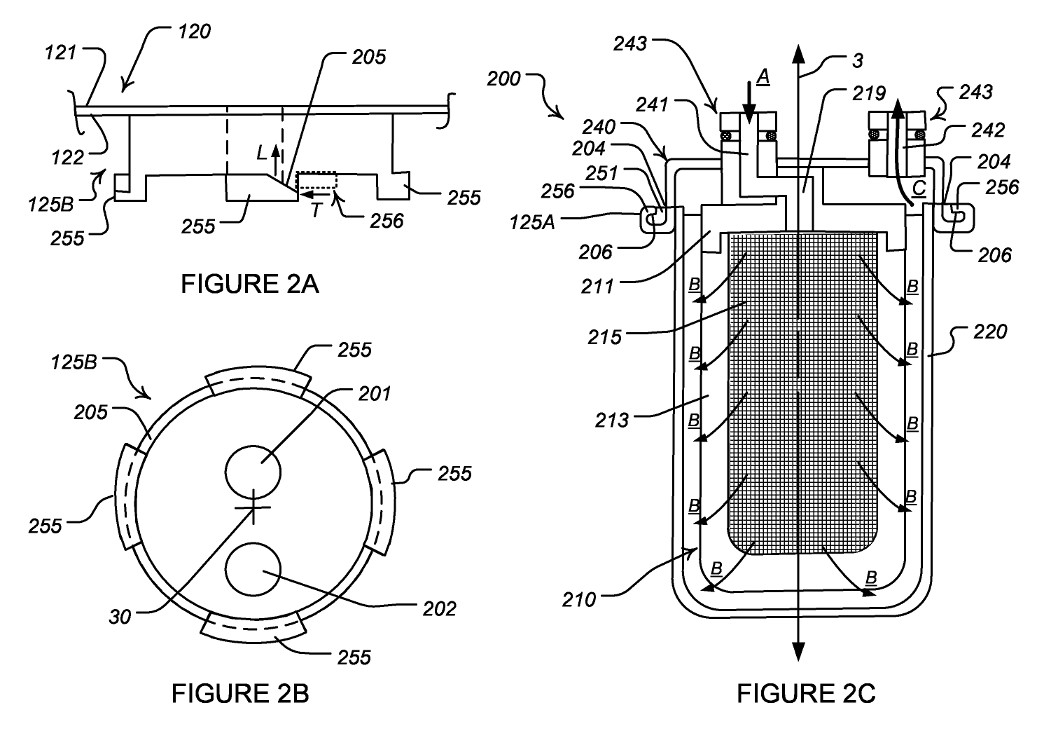

With reference to FIG. 2C, which is a cross-section view through section line A-A of FIG. 1, each mounting ring 125A includes an annular groove 251 that has a lip portion 256 for engaging an interlocking feature 255 of quick connect member 125B, which is shown in FIGS. 2A-B. According to the illustrated embodiment, when ring 125A abuts a shoulder 204 of filter module 200 and each interlocking feature 255 is inserted into groove 251, the rotation of ring 125A, per arrow T, causes each feature 255 to engage and interlock with the corresponding lip portion 256. With further reference to FIGS. 2A and 2C, a camming interface between a lower surface 206 of lip portion 256 and a ramped surface 205 of feature 255, upon rotation per arrow T, lifts module 200, per arrow L, into secure connection with the associated manifold part, and results in the interlocking engagement between lip portion 256 and feature 255. FIGS. 2A-B show quick connect member 125B including four features 255, spaced apart from one another around a perimeter thereof, to mate with four corresponding interlocking lip portions 256 of mounting ring 125A, which are similarly spaced apart from one another. According to some preferred embodiments the camming interface between mounting ring 125A and quick connect member 125B requires only a ¼ turn for interlocking engagement. Ring 125A may likewise be rotated in an opposite direction to that indicated by arrow T, for example, via lever 250, in order to disconnect module 200 from the associated manifold part.

FIG. 2C further illustrates filter module 200 including a filter element 210 contained within sidewall 220 and a cap member 240 of module 200; cap member 240 is shown including an inlet port 241, for the passage of fluid into filter element 210, and an outlet port 242, for the passage of filtered fluid out from module 200. With further reference to FIG. 2C, inlet port 241 and outlet port 242 of each filter module 200 are each surrounded by a male fitting 243, which may be fitted with an O-ring type seal, as shown, for a sealed push-in type connection with manifold parts 130A, 130B, which will be described in greater detail below, in conjunction with FIG. 3. The push-in type connection in conjunction with the above-described quick-connect-and-release type coupling of mounting ring 125A and quick connect member 125B keep the assembly and maintenance of system 100 relatively simple. For example, no tools are required for connection and disconnection of modules 200 from the manifold parts 130A, 130B of system 100, and, rather than having to manipulate, for example, rotate, each filter module 200 to make the connection with the corresponding manifold part 130A, 130B, each module 200 need only be held in place while simply rotating the corresponding mounting ring 125A to lift each module 200 for the push-in connection.

FIG. 2C further illustrates filter element 210 including a core 215, a porous ceramic sidewall 213, which surrounds core 215, and a cap 211, which includes an inflow channel 219 approximately aligned with core 215. According to the illustrated embodiment, cap 211 is positioned with respect to cap member 240, such that inflow channel 219 and core 215 of filter element 210 are in fluid communication with inlet port 241, in order to receive flow of fluid, per arrow A, which fluid then passes through filter element 210 and into the surrounding space within sidewall 220, per arrows B, and then out from filter module 20, through outlet port 242, per arrow C. According to preferred embodiments of the present invention, core 215 of filter element 210 is formed by an activated carbon, for example, a granular activated carbon; and porous ceramic sidewall 213 of filter element 210 is formed, for example, by casting, to include an internal space, which is filled with the activated carbon. A self-sanitizing agent that prevents bacterial growth, for example, approximately 0.05% silver, may be embedded in ceramic sidewall 213, and the porosity of sidewall 213 may provide up to 99.99% filtering efficiency at approximately 0.7 microns.

Turning now to FIG. 3, which is a cross-section view taken along an extent of inflow and outflow channels of the modular manifold assembly of filter system 100 (FIG. 1), the inflow channel of the manifold assembly is shown including a first channel portion 131I (of modular manifold part 130A) and a second channel portion 132I (of modular manifold part 130B), and the outflow channel of the manifold assembly is shown including a second channel portion 132O (of first part 130A) and a first channel portion 131O (of second part 130B). With reference to FIGS. 1 and 2C, in conjunction with FIG. 3, it may be appreciated that inlet port 241 of each filter module 200 is coupled to a corresponding side opening 40-241, 41-241 of the inflow channel of the modular manifold assembly, for fluid communication therebetween, and that outlet port 242 of each filter module is coupled to a corresponding side opening 40-242, 41-242 of the outflow channel, for fluid communication therebetween. With reference back to FIG. 2C, openings 201 and 202 are shown, and one of openings 201, 202 is indicated with dashed lines in FIG. 2B, in order to indicate that openings 201, 202 extend from first side 121 of mounting bracket 120 to second side 122 of mounting bracket 120 so as to provide access, from second side 122, to corresponding side openings 40-241, 40-242 of the corresponding manifold part 130A, 130B. Thus, when each of modules 200 are installed so that the corresponding inlet port 241 and outlet port 242 are coupled to the corresponding side openings 40-241, 40-242, flow of fluid enters filter system 100, per arrow I, at opening 311A, and is distributed, in parallel, by the inflow channel of the modular manifold assembly, into each filter module 200, through openings 40-241 and 41-241. The filtered fluid then, likewise, flows in parallel out from each filter module 200 and into the outflow channel of the modular manifold assembly, through openings 40-242 and 41-242, to exit from filter system 100, per arrow O, at opening 311B. FIGS. 1 and 3 show openings 311A, 311B surrounded by male threaded fittings 372, preferably configured to facilitate coupling of filter system 100 within a standard supply pipeline.

With further reference to FIGS. 2B and 2C, it should be noted that inlet port 241 and outlet port 242 are asymmetrically positioned with respect to a central longitudinal axis 3 of module 200, such that inlet port 241 is located closer to axis 3 than outlet port 242. Likewise, openings 201 and 202 (seen in FIG. 2B), that extend from first side 121 to second side 122 of mounting bracket 120, are asymmetrically positioned with respect to a center point 30 of a perimeter wall 205 of quick connect member 125B. This asymmetrical positioning of ports 241, 242 and openings 201, 202 provide a keying feature to guide installation of module 200 so that inlet port 241 is mated with the proper side opening for the inflow channel of the manifold assembly and outlet port 242 is mated with the proper side opening for the outflow channel of assembly, when axis 3 and center point 30 are approximately aligned.

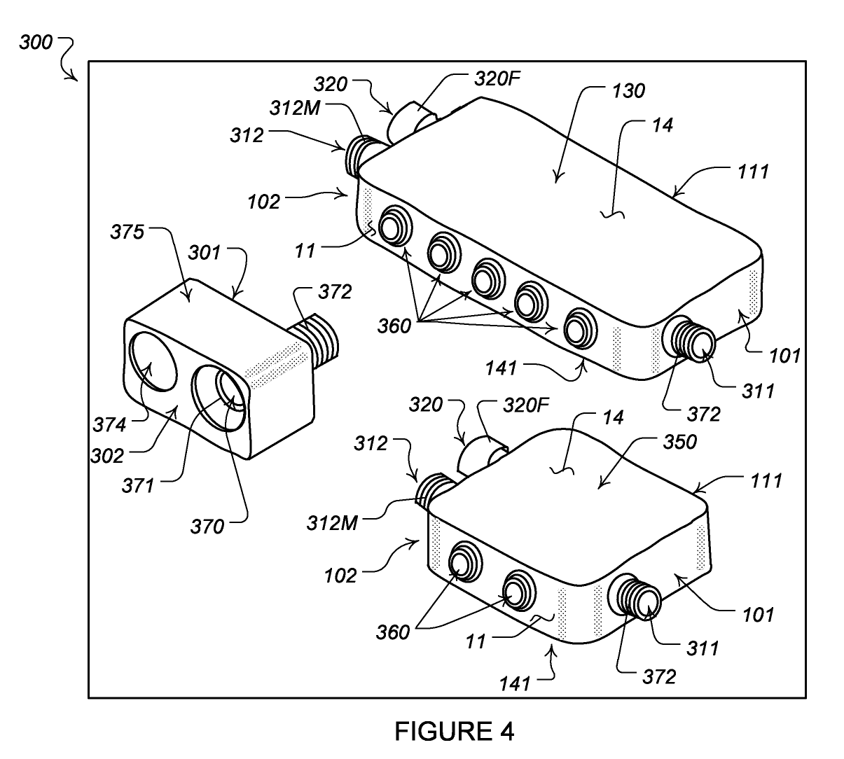

With further reference to FIG. 3, it may be appreciated that modular manifold parts 130A and 130B are very similar. In fact, according to preferred embodiments, parts 130A, 130B are identical and are identified as part 130 in FIG. 4. FIG. 4 is a perspective view of a group of modular manifold parts 300, which may be represented in a modular manifold kit, according to some embodiments of the present invention. The kit, which includes the types of parts shown in group 300, may be used to assemble a filter system by selecting the types of modular manifold parts according to the number of filter modules 200 desired for the system. FIG. 4 illustrates group 300 including two configurations of a first type of part 130, 350 and one configuration of a second type of part 375, according to some embodiments.

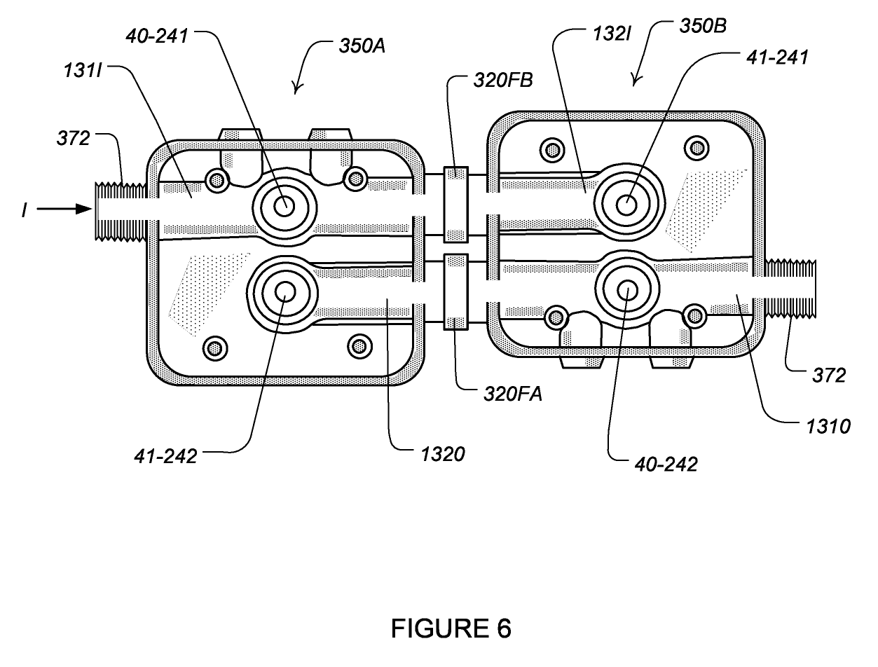

FIG. 4 further illustrates each of first type of part 130, 350 including an upper side 14, a lower side 141, a first end 101, a second end 102, a first face 11 and a second face 111. With reference back to FIGS. 1 and 3, it may be appreciated that openings, for example 40-241, 40-242, which extend into respective first and second channel portions 131, 132 are formed in lower side 141, which rests against first side 121 of mounting bracket 120. According to FIG. 4, each of the first type of modular manifold parts 130, 350 include a male threaded fitting, which surrounds an opening 311 (corresponding to openings 311A, 311B of parts 130A, 130B in FIGS. 1 and 3), at first end 101, and male and female push-in type fittings 312M and 320F, which surround openings 312 and 320, respectively, at second end 102. Fitting 312M is configured to mate with fitting 320F so that two of the first type of part 130, 350 may be coupled together, end-to-end, at second ends 102. For example, two of parts 130 may be coupled together to accommodate four filter modules 200 (FIG. 3); two of parts 350 may be coupled together to accommodate two filter modules 200 (FIG. 6); or part 130 and part 350 may be coupled together to accommodate three filter modules (not shown). With reference back to FIG. 3, two of first type of part 130 (designated 130A and 130B) are coupled together by the mating 320FA of female push-in type fitting 320F of part 350A with male push-in type fitting 312M of part 350B, and the mating 320FB of female push-in type fitting 320F of part 350B with male push-in type fitting 312M of part 350A.

Parts 130 and 350 are also shown including optional auxiliary ports 360 formed in first face 11 in order to provide fluid communication with first channel portion 131 of each part. Depending upon the orientation of parts 130 and 350 within a modular manifold assembly, auxiliary ports 360 either provide inflow from additional sources to the filter system, or provide outflow of filtered fluid from the filter system to additional destinations. Optional auxiliary ports 360 may be originally formed as blind bores that can subsequently be drilled out to communicate with the corresponding channel portion 131, according to the type of modular assembly desired; alternatively, optional ports 360 may be originally formed to communicate with the channel portion 131 and group 300 further includes caps (not shown) for auxiliary ports 360, to seal off some or all of the ports 360, when not in use.

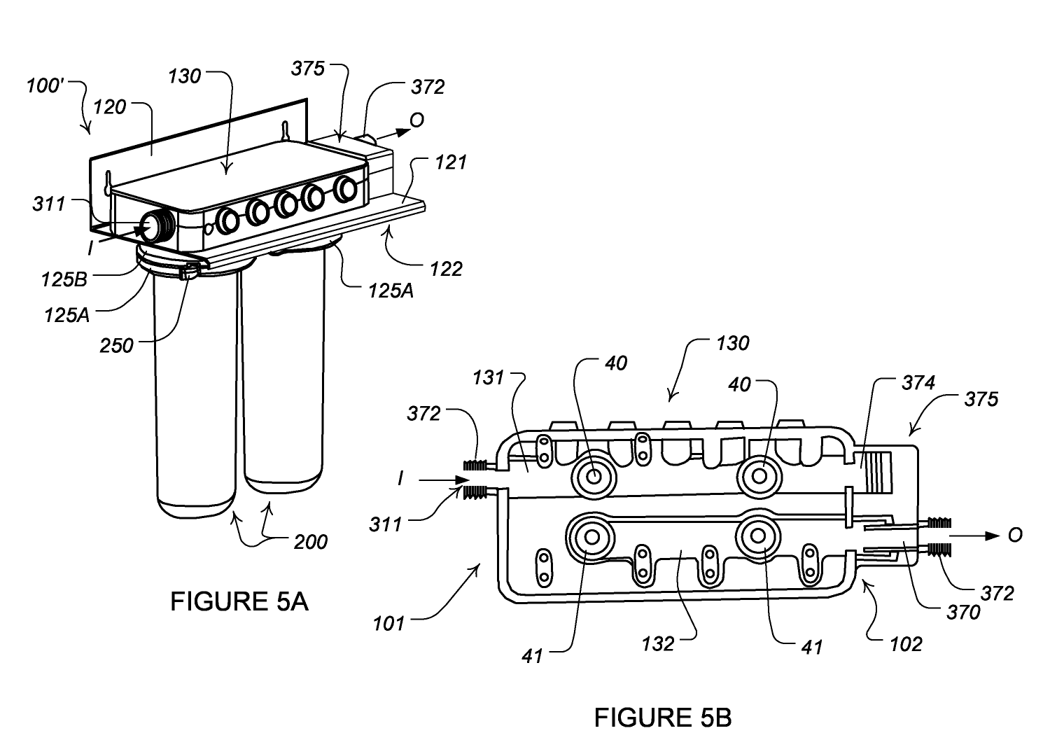

FIG. 4 further illustrates second type of modular manifold part 375 including a first end 301, a second end 302, a dead-end bore 374 having an opening at second end 302, and a channel 370 extending from an opening at first end 301 to an opening at second end 302. Second type of part 375 is configured to serve as both an end cap and an adapter for one of the first type of modular manifold parts 130, 350, when a filter system is designed to include only one filter module 200 in conjunction with manifold part 350, or only two filter modules 200 in conjunction with manifold part 130, for example as is shown in FIG. 5A. According to the illustrated embodiment, dead-end bore 374 is surrounded by a female push-in type fitting that is adapted to mate with male push-in fitting 312M of either of parts 130, 350, and, thereby, close off opening 312 to terminate first channel portion 131, for example, as is illustrated for part 130 in FIG. 5B. Furthermore, an internal male push-in type fitting 371, within the opening of channel 370, at second end 302, mates with female fitting 320F of either of parts 130, 350, thereby converting female fitting 320F to male threaded fitting 372 that surrounds the opening at first end 301.

FIG. 5A is a perspective view an alternative modular assembly of a filter system 100′, according to some embodiments; and FIG. 5B is a cross-section view taken along an extent of inflow and outflow channels the modular manifold assembly of system 100′. With reference to FIG. 5A, first type of manifold part 130 and second type of manifold part 375 are supported on first side 121 of mounting bracket 120 and two filter modules 200 are joined to manifold part 130 and to mounting bracket 120, so as to extend from second side 122 of bracket 120, in a manner previously describe in conjunction with FIGS. 1-2C. FIG. 5B illustrates first type of part 130 coupled to second type of part 375 by the mating of female fitting 320F of part 130 with internal male push-in type fitting 371 of part 375, and the mating of male fitting 312M of part 130 with the female push-in type fitting that surrounds the opening into dead-end bore 374 of part 375. FIG. 5B further illustrates the inflow channel of the assembly formed by first channel portion 131 of part 130, and the outflow channel of the assembly formed by second channel portion 132 of part 130, which communicates with channel 370 of part 375. With reference back to FIGS. 2C and 5A, in conjunction with FIG. 5B, it may be appreciated that inlet port 241 of each filter module 200 may be coupled to a corresponding side opening 40 of first channel portion 130, and the outlet port 242 of each filter module to a corresponding side opening 41 of second channel portion 132. According to an exemplary embodiment, a length of the illustrated modular manifold assembly, from opening 311 to threaded fitting 372, is between approximately 12.5 inches and approximately 13.5 inches.

FIG. 6 is a cross-section view taken along an extent of inflow and outflow channels of yet another alternative modular manifold assembly, which is configured for a filter system that includes two filter modules 200. FIG. 6 illustrates two of parts 350, designated as 350A and 350B, coupled together by the mating 320FA of female push-in type fitting 320F of part 350A with male push-in type fitting 312M of part 350B, and the mating 320FB of female push-in type fitting 320F of part 350B with male push-in type fitting 312M of part 350A. FIG. 6 further illustrates the inflow channel of the assembly formed by first channel portion 131 of part 350A, designated as 131I, and a second channel portion 132 of part 350B, designated as 132I, and the outflow channel of the assembly formed by second channel portion 132 of part 350A, designated at 132O, and first channel portion 131 of part 350B, designated as 131O. With reference back to FIG. 2C, in conjunction with FIG. 6, it may be appreciated that inlet port 241 of each filter module 200 may be coupled to the corresponding side opening 40-241, 41-241 of first and second channel portions 131I and 1322I, respectively, and the outlet port 242 of each filter module 200 to the corresponding side opening 40-242, 41-242 of second and first channel portions 132O and 131O, respectively.

In the foregoing detailed description, the invention has been described with reference to specific embodiments. However, it may be appreciated that various modifications and changes can be made without departing from the scope of the invention as set forth in the appended claims.

1. A modular assembly of a filtering system comprising:
at least two filter modules, each filter module including a filtering core, a space surrounding the core, a sidewall containing the core and the space, an inlet port in fluid communication with the core and having a fitting extending from a first end of the sidewall, an outlet port in fluid communication with the space and having a fitting extending from the first end of the sidewall, and a shoulder extending around the first end of the sidewall;
two manifold parts, a first of the two parts being a first type of part and a second of the two parts being one of: the first type of part and a second type of part, the first type of part including a first end, a second end, a first channel portion extending from a first, main opening at the first end to a second opening at the second end, a second channel portion extending from a third opening at the second end to a terminal end wall within the part, between the first and second ends, a lower side extending between the first and second ends, a first pair of side openings formed in the lower side and extending into the first channel portion, and a second pair of side openings formed in the lower side and extending into the second channel portion, the outlet port fitting of each filter module engaging with a corresponding opening of one of the first and second pairs of side openings, and the inlet port fitting of each filter module engaging with a corresponding opening of the other of the first and second pairs of side openings;
a mounting bracket including a first side, against which the lower side of the first type of part rests, a second side, opposite the first side, openings extending from the first side to the second side to provide access to the first and second pairs of side openings of the first type of part, from the second side, and at least two quick connect members extending from the second side of the bracket, each quick connect member supporting a corresponding filter module and including an interlocking feature having a ramped surface; and
two mounting rings, each ring slideably engaged about the sidewall of the corresponding filter module and including an annular groove, each annular groove having a lip portion that engages and mates with the interlocking feature of the corresponding quick connect member in order to enable the support of the filter module;
wherein, when each ring abuts the shoulder of the corresponding filter module and is rotated about the sidewall thereof, engagement of the lip portion with the ramped surface of the interlocking feature of the quick connect member on the second side of the mounting bracket either lifts or lowers the filter module with respect to the first type of part;
the lifting brings the inlet and outlet ports of the filter module into fluid communication with the corresponding side openings of the first type of part; and
the lowering releases the inlet and outlet ports from the fluid communication.

2. The assembly of claim 1, wherein:
the at least two filter modules comprises four filter modules; and
the second of the two manifold parts is the first type of part.

3. The assembly of claim 2, wherein:
the first type of part further includes a first type of fitting surrounding the second opening and a second type of fitting surrounding the third opening, the second type of fitting configured to mate with the first type of fitting;
the fitting surrounding the second opening of the first manifold part is mated with the fitting surrounding the third opening of the second manifold part, so that the first channel portion of the first manifold part is in fluid communication with the second channel portion of the second manifold part; and
the fitting surrounding the second opening of the second manifold part is mated with the fitting surrounding the third opening of the first manifold part, so that the first channel portion of the second manifold part is in fluid communication with the second channel portion of the first manifold part.

4. The assembly of claim 1, wherein:
the second of the two manifold parts is the second type of part;
the second type of part comprises a first end, a second end, opposite the first end, a dead-end bore having an opening at the second end, and a channel extending from an opening at the first end to an opening at the second end;
the opening of the dead-end bore of the second manifold part is mated with the second opening of the first manifold part, so that the dead-end bore terminates the first channel portion of the first manifold part in close proximity to the second opening thereof; and
the opening of the channel at the second end of the second manifold part is mated with the third opening of the first manifold part to extend the second channel portion of the first manifold part to the opening of the channel at the first end of the second manifold part.

5. The assembly of claim 1, wherein the first type of part further includes at least one auxiliary port in fluid communication with the first channel portion.

6. The assembly of claim 1, wherein:
each filter module includes a longitudinal axis on which the first end of the corresponding sidewall is centered;
the inlet and outlet port fittings of each filter module are asymmetrically positioned with respect to the corresponding longitudinal axis, such that inlet port fitting of each filter module is located closer to the axis than the corresponding outlet portion fitting;
each quick connect member of the mounting bracket includes a perimeter wall within which the first end of the sidewall of the corresponding filter module extends such that the first end of the sidewall and the perimeter wall are approximately concentric about the longitudinal axis; and
the openings that extend from the first side of the mounting bracket to the second side of the mounting bracket comprise a first opening and a second opening within the perimeter wall of each quick connect member, the first and second openings being asymmetrically positioned such that each first opening is located closer to the corresponding longitudinal axis than each second opening, and each first opening is approximately aligned with the inlet port fitting of the corresponding filter module and each second opening is approximately aligned with the outlet port fitting of the corresponding filter module.

7. The assembly of claim 1, wherein each of the two mounting rings further include a lever that facilitates the rotation of each ring about the sidewall of the corresponding filter module.

8. A modular manifold kit for a modular assembly of a filtering system that includes at least two filter modules, each filter module including an inlet port and an outlet port, each port having a fitting, the kit comprising at least two modular manifold parts, a first of the at least two parts being a first type of part and a second of the at least two parts being one of: the first type of part and a second type of part; wherein:
the first type of part comprises:
a first end and a second end, opposite the first end;
a first face and a second face, the first and second faces each extending from the first end to the second end and opposite one another;
an upper side and a lower side, the upper and lower sides extending between the first and second ends and the first and second faces and opposite one another;
a first channel portion extending from a first, main opening, at the first end, to a second opening, at the second end, the main opening being configured to facilitate coupling of the filter system to a standard fluid supply pipeline;
a second channel portion extending from a third opening, at the second end to a terminal end wall within the part, between the first and second ends, the first and second faces and the upper and lower sides;
a first type of fitting surrounding the second opening and a second type of fitting surrounding the third opening, the second type of fitting configured to mate with the first type of fitting so that, if the at least two modular manifold parts comprises two of the first type of part, the two parts can be coupled together, via the mating of the first and second types of fittings, so that the second opening of a first of the two parts is in fluid communication with the third opening of a second of the two parts, and vice versa; and
a first pair of side openings formed in the lower side and extending into the first channel portion and a second pair of side openings formed in the lower side and extending into the second channel portion, each side opening being sized to receive either an inlet port fitting or an outlet port fitting of each of the at least two filter modules in order to provide fluid communication between the respective channel portion and port; and
the second type of part comprises:
a first end and a second end, opposite the first end;
a dead-end bore having an opening at the second end and being configured to mate with the first type of fitting surrounding the second opening of the first type of part, such that, when mated, the dead-end bore terminates the first channel portion of the first type of part in close proximity to the second opening;
a channel extending from an opening at the first end to an opening at the second end, the opening of the channel at the first end of the second type of part being configured to facilitate coupling of the filter system to a standard fluid supply pipeline; and
a fitting surrounding the opening of the channel at the second end of the second type of part, the fitting configured to mate with the second type of fitting surrounding the third opening of the first type of part.

9. The kit of claim 8, wherein the first type of part further comprises at least one auxiliary port in fluid communication with the first channel portion and accessible from one of the first and second faces.

10. The kit of claim 9, further comprising at least one cap, each of the at least one cap configured to mate with one of the at least one auxiliary port to close off the port when not in use.

11. The kit of claim 8, wherein a spacing between each of the first pair of side openings is approximately equal to a spacing between each of the second pair of side openings and the first pair of side openings is approximately aligned with the second pair of side openings.
